(19) United States
(12) Patent Application Publication
(10) Pub. No.: US 2026/0256106 A1
(43) Pub. Date: Sep. 3, 2026

(54) MACHINE FOR METERING DENSE DAIRY PRODUCTS

(71) Applicant: Carmine MAROTTA, Nonantola (MO) (IT)

(72) Inventor: Carmine MAROTTA, Nonantola (MO) (IT)

(21) Appl. No.: 19/489,975

(22) PCT Filed: Jun. 3, 2024
(86) PCT No.: PCT/IB2024/055407

§ 371 Date: Dec. 4, 2025

(30) Foreign Application Priority Data
Jun. 5, 2023 (IT) 102023000011394

(51) Int. Cl. A01J 25/08; A01J 25/00

(52) U.S. Cl. CPC A01J 25/08; A01J 25/007

(57) ABSTRACT

The machine (1) for metering dense dairy products comprises:
at least one base frame (2);
one container body (3) defining a cavity (4) adapted to contain a dense dairy product;
one metering device (5) associated with the base frame (2) and adapted to dispense portions of the dairy product;
one transfer assembly (6) associated with the base frame (2), adapted to transfer the dairy product from the container body (3) to the metering device (5) and provided with at least one connecting duct (7) communicating with the cavity (4) and connected to the metering device (5); where the transfer assembly (6) comprises at least one pusher device (8) movable within the container body (3) and adapted to exert a pressing force on the dairy product, the pressing force causing the dairy product to flow out of the container body (3) through the connecting duct (7).

### TECHNICAL FIELD

The present invention relates to a machine for metering dense dairy products.

### BACKGROUND ART

In the dairy sector, the production of creamy, soft or semi-hard cheese, such as e.g. goat cheese, is well known.

These types of cheese are prepared from a dairy product in the form of a dense paste, namely curd, which is obtained by heat and/or fermentation treatment of the milk and which is then subjected to molding and eventually aged to obtain the finished cheese.

For this purpose, production plants are provided with machines designed to transfer and meter portions of the dairy product.

The machines of known type comprise a metering device adapted to dispense portions of the dairy product and a pumping assembly adapted to suck the dairy product from a special container, within which the dairy product is previously prepared and to transfer it to the metering device.

The machines of known type do, however, have some drawbacks related to the high viscosity of such dairy products. Indeed, in these cases, the suction of the dairy product very often results in the formation of air pockets upstream of the metering device, which can lead to malfunctions or even interruptions in the operation of the pumping assembly. In addition to this, the functionality of the metering device is also suboptimal and the dispensing of the dairy product is inaccurate and discontinuous.

### DESCRIPTION OF THE INVENTION

The main aim of the present invention is to devise a machine for metering dense dairy products which allows avoiding the formation of air pockets upstream of the metering device.

Another object of the present invention is to devise a machine for metering dense dairy products which allows constant and uninterrupted transfer of the dairy product to the metering device.

A further object of the present invention is to devise a machine for metering dense dairy products which enables accurate metering of the dairy product.

Another object of the present invention is to devise a machine for metering dense dairy products which allows the aforementioned drawbacks of the prior art to be overcome within the framework of a simple, rational, easy and efficient to use as well as cost-effective solution.

The aforementioned objects are achieved by this machine for metering dense dairy products having the characteristics of claim 1.

### BRIEF DESCRIPTION OF THE DRAWINGS

Other characteristics and advantages of the present invention will become more apparent from the description of a preferred, but not exclusive, embodiment of a machine for metering dense dairy products, illustrated by way of an indicative, yet non-limiting example, in the accompanying tables of drawings in which:

FIG. 1 is an axonometric view of a machine according to the invention;

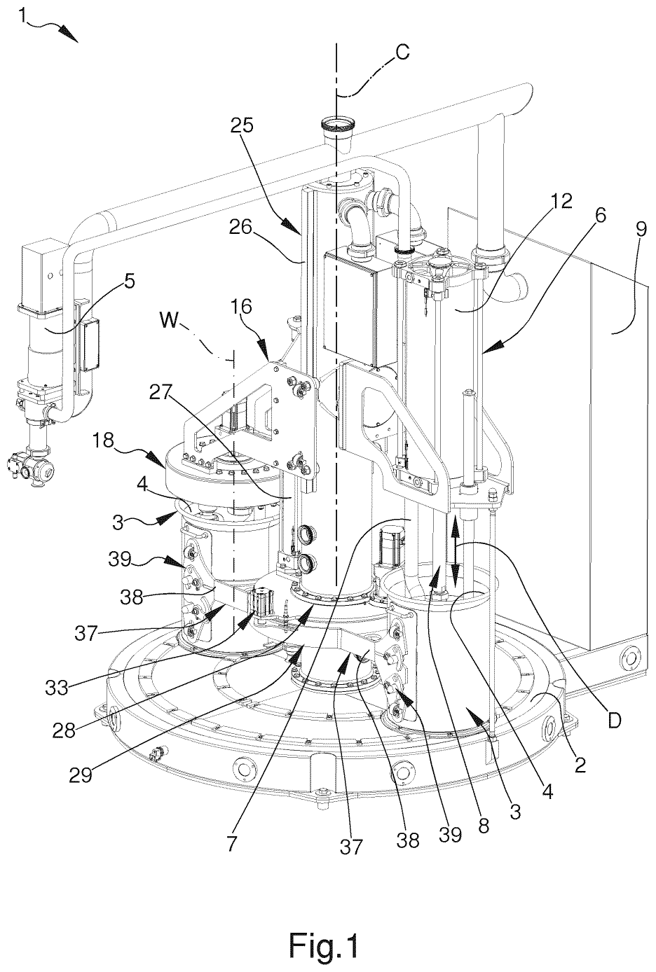

FIGS. 2 and 3 are cross-sectional side views of the transfer assembly according to the invention, in two different operational positions;

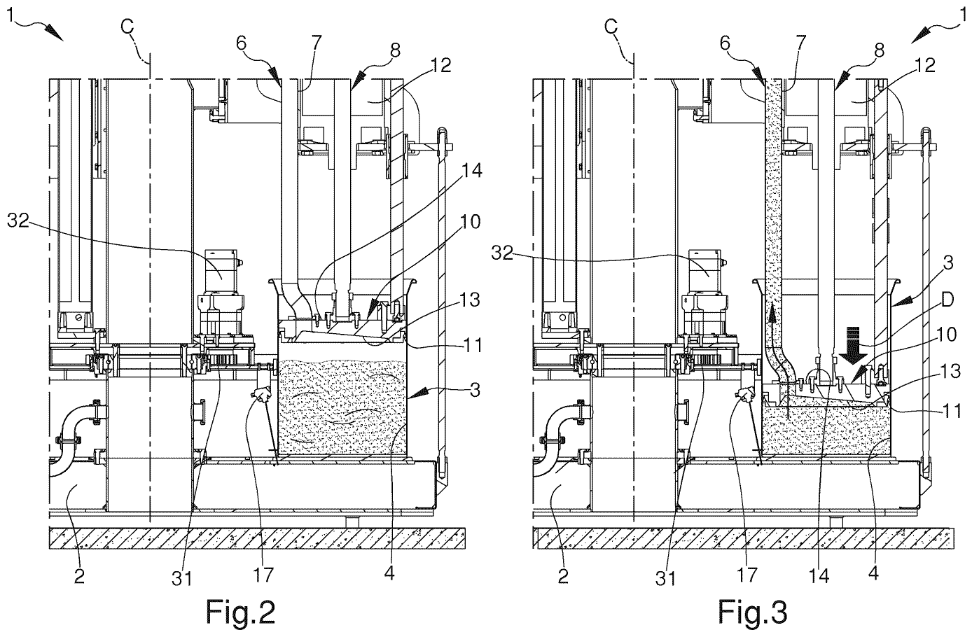

FIG. 4 is an axonometric view of the machine according to the invention, with the stirring device in the receding position and the pusher device in the home position;

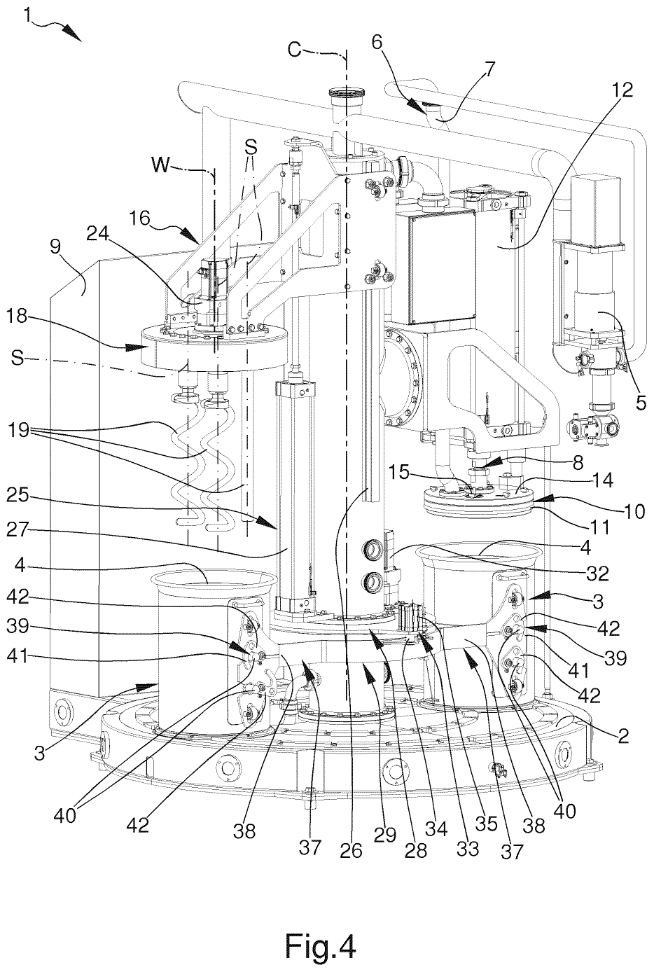

FIG. 5 is a detailed axonometric view of the stirring device according to the invention;

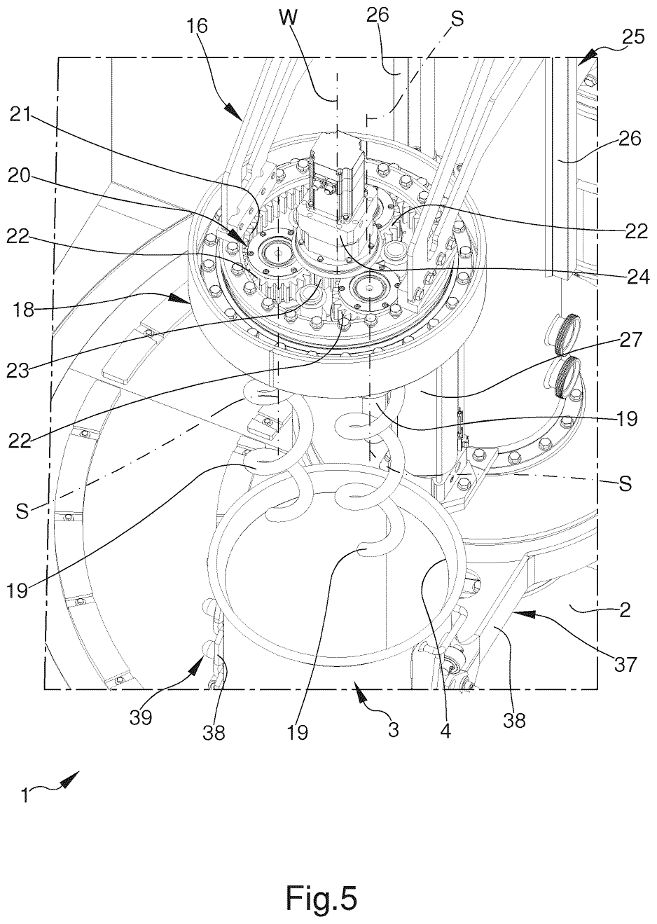

FIG. 6 is a detailed axonometric view of the movement assembly according to the invention.

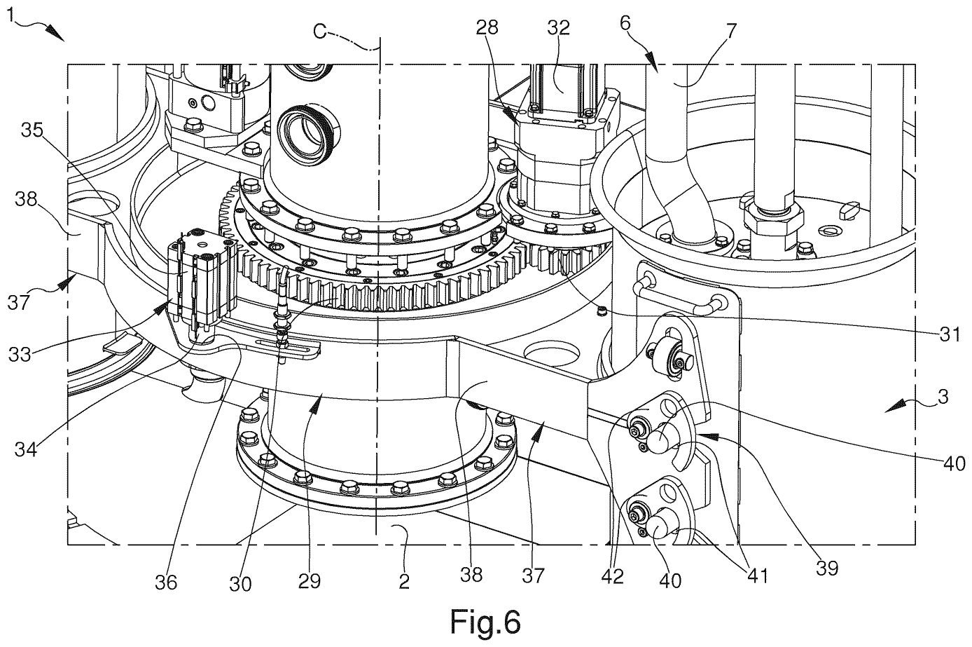

### EMBODIMENTS OF THE INVENTION

With particular reference to these figures, reference numeral 1 globally denotes a machine for metering dense dairy products.

In the context of this disclosure, the term “dense dairy products” refers to a product derived from the thermal and/or fermentative processing of milk that is a very viscous and dense paste. Such types of dairy products are generally divided into portions which are subjected to molding and possible aging, to obtain a finished soft or semi-hard cheese, such as e.g. goat cheese.

The machine 1 comprises:
at least one base frame 2;
at least one container body 3 defining a cavity 4 adapted to contain a dense dairy product;
at least one metering device 5 associated with the base frame 2 and adapted to dispense portions of the dairy product; and
at least one transfer assembly 6 associated with the base frame 2, adapted to transfer the dairy product from the container body 3 to the metering device 5 and provided with at least one connecting duct 7 communicating with the cavity 4 and connected to the metering device 5.

According to the invention, the transfer assembly 6 comprises at least one pusher device 8 movable within the container body 3 and adapted to exert a pressing force on the dairy product, where the pressing force causes the dairy product to flow out of the container body 3 through the connecting duct 7.

In actual facts, the dairy product is not sucked in through the connecting duct 7 but is pushed into it by the pusher device 8 up to the metering device 5. In this way, the formation of air pockets can be avoided so that the supply of the dairy product to the metering device 5 is substantially uninterrupted. The container body 3 is open at the top and comprises a bottom wall and at least one lateral wall defining the cavity 4.

In accordance with the embodiment shown in the figures, the container body 3 has a substantially cylindrical conformation. It cannot, however, be ruled out that the container body 3 may have a different conformation.

The container body 3 is associated with the base frame 2 in a removable manner so that it can be filled with the dairy product and/or so as to carry out the cleaning operations.

The metering device 5 is of the type known to the engineer in the field and will not be described in detail in this disclosure. In accordance with the embodiment shown in the figures, in particular, the metering device 5 is of the type of a piston metering device.

Conveniently, the machine 1 also comprises at least one electronic unit 9 operationally connected to the metering device 5 and to the pusher device 8 and configured to operate the latter synchronously to dispense the portions of dairy product.

Advantageously, the pusher device 8 comprises at least one plunger body 10 which can be moved along a substantially vertical operational direction D between a home position, wherein it is moved away from the container body 3, and at least one operational position, wherein it is arranged within the container body itself.

The plunger body 10 has a substantially complementary conformation to the cross section of the container body 3.

In the embodiment shown in the figures, the plunger body 10 has a substantially circular conformation.

In actual facts, in the operational position, the plunger body 10 is arranged to close the container body 3 and to bound the cavity 4 superiorly.

The movement of the plunger body 10 along the operational direction D, towards the operational position, causes the generation of the pressing force on the dairy product.

Conveniently, the plunger body 10 comprises at least one sealing element 11 configured to adhere to the inner walls of the container body 3. The sealing element 11 ensures perfect adhesion of the plunger body 10 to the container body 3 and allows avoiding possible spillage of the dairy product due to the pressure force acting thereon.

The pusher device 8 also comprises actuating means 12 connected to the plunger body 10 and adapted to move the latter along the operational direction D.

The electronic unit 9 is operationally connected to the actuating means 12 and is configured to operate the latter to move the plunger body 10 between the home position and the operational position.

In accordance with the embodiment shown in the figures, the actuating means 12 comprise a pneumatic cylinder. In accordance with an alternative embodiment, not shown in detail in the figures, the actuating means 12 may comprise an electro-mechanical drive system, e.g. provided with a rack, extending along the operational direction D, and a pinion meshing the rack and operable by means of an electric motor.

Advantageously, the connecting duct 7 is associated with the plunger body 10.

In actual facts, the connecting duct 7 is connected to the cavity 4 through the plunger body 10.

Therefore, the connecting duct 7 runs partly parallel to the operational direction.

The movement of the plunger body 10 towards the operational position results in the outflow of the dairy product through the plunger body itself, along a direction opposite the operational direction D.

In addition, the connecting duct 7 is at least partly locked together with the plunger body 10 in the movement between the home position and the operational position.

The connecting duct 7 comprises a first rigid stretch attached to the plunger body 10 and a second flexible stretch connected to the metering device 5. The second flexible stretch allows partial deformation of the connecting duct 7 during the movement of the plunger body 10.

Conveniently, the plunger body 10 comprises an inner surface 13 facing, in the operational position, towards the cavity 4 and adapted to contact the dairy product and an outer surface 14 opposite the inner surface 13.

The connecting duct 7 exits on the inner surface 13 of the plunger body 10.

The inner surface 13 is, in addition, appropriately sloped towards the connecting duct 7 to convey the dairy product towards the connecting duct itself.

The pusher device 8 also comprises at least one relief valve 15 associated with the plunger body 10 and adapted to allow air to flow from/to the cavity 4.

The relief valve 15 allows air to flow out in the movement of the plunger body 10 from the home position to the operational position and air to enter in the opposite movement. In this way, the pusher device 8 ensures the absence of air in the cavity 4 during dairy product transfer operations and promotes the pulling of the plunger body 10 out of the container body 3 when coming back to the home position.

Advantageously, the machine 1 also comprises a mixing assembly 16 which is adapted to mix the dairy product within the container body 3.

The container body 3 is movable between a mixing position, wherein it is arranged where the mixing assembly 16 is located, and a metering position, wherein it is arranged where the transfer assembly 6 is located.

The machine 1 thus enables both the preparation of the dairy product and the metering thereof, by means of a single piece of equipment.

Appropriately, therefore, the machine 1 also comprises at least one presence sensor 17 operationally connected to the electronic unit 9 and configured to detect the presence of the container body 3 where at least one of either the mixing position or the metering position is located.

The mixing assembly 16 comprises at least one stirring device 18 provided with at least one mixing element 19 insertable into the container body 3.

The mixing element 19 is intended to mix the ingredients required for the production of the dairy product.

The mixing assembly 16 may also comprise weight-sensing means, not shown in detail in the figures, arranged where the container body 3 is located and configured to sense the weight of the container body itself. The weight-sensing means e.g. comprise a load cell and allow direct loading of the ingredients into the container body 3 with the latter in the mixing position.

The stirring device 18 is movable along a substantially vertical axis of work W between a receding position, wherein the mixing element 19 is pulled out of the container body 3, and a working position, wherein the mixing element 19 is arranged within the container body 3.

With the stirring device 18 in the receding position and the pusher device 8 in the home position, the container body 3 is movable between the mixing position and the metering position, as will be better described later in this disclosure.

The mixing element 19 is movable in rotation around the axis of work W.

In detail, the mixing element 19 develops along a relevant axis of development S substantially parallel to the axis of work W.

The mixing element 19 is, in addition, rotatable around the axis of development S.

In actual facts, the mixing element 19 is rotatable on itself and around the axis of work W.

In accordance with the embodiment shown in the figures, the stirring device 18 comprises a plurality of mixing elements 19.

The mixing elements are arranged equidistant from each other and from the axis of work W.

The mixing element 19 can have a spiral or straight development.

Still with reference to the embodiment shown in the figures, the stirring device 18 comprises two mixing elements 19 having a spiral development and a mixing element 19 having a straight development.

Conveniently, the stirring device 18 also comprises an actuator system 20 adapted to move the mixing elements 19. The actuator system 20 comprises:
a rack member 21 of circular conformation, having its center at the axis of work W;
a first sprocket 22 associated with each mixing element 19, having its center at the respective axis of development S and meshing the rack member 21; and
a second sprocket 23 having its center at the axis of work W and meshing each of the first sprockets 22.

The actuator system 20 also comprises an electric motor 24 associated with the second sprocket 23.

The rotation of the second sprocket 23 around the axis of work W results in the rotation of the first sprockets 22 on themselves and along the rack member 21, around the axis of work W.

Advantageously, the mixing assembly 16 comprises displacement means 25 adapted to move the stirring device 18 between the receding position and the working position.

The displacement means 25 comprise:
at least one guide unit 26 associated with the base frame 2, extending parallel to the axis of work W and supporting the stirring device 18 by sliding; and
at least one actuator device 27 positioned between the base frame 2 and the stirring device 18.

The actuator device 27 is of the type of a pneumatic cylinder.

The electronic unit 9 is operationally connected to the actuator device 27 and is configured to operate the latter to move the stirrer device 18 between the receding position and the working position.

Conveniently, the mixing assembly 16 and the transfer assembly 6 are arranged opposite each other with respect to a substantially vertical central axis C. In detail, the mixing assembly 16 and the transfer assembly 6 are arranged opposite each other with respect to a vertical plane passing through the central axis C.

The machine 1 also comprises at least one movement assembly 28 associated with the base frame 2 and configured to move the container body 3 in rotation around the central axis C between the mixing position and the metering position.

Thanks to the movement assembly 28, the container body 3 is automatically moved between the mixing position and the metering position.

In detail, the electronic unit 9 is operationally connected to the movement assembly 28 and is configured to drive the latter to move the container body 3 between the mixing position and the metering position.

The movement assembly 28 comprises a holding structure 29 adapted to retain the container body 3 and associated rotatable with the base frame 2 around the central axis C and an actuator system 20 adapted to set the holding structure 29 in rotation.

The holding structure 29 is adapted to retain the container body 3 in the movement between the mixing position and the metering position.

Advantageously, the actuator system 20 comprises:
at least one rack body 30 of circular conformation, locked together with the holding structure 29;
at least one pinion element 31 meshing the rack body 30; and
at least one motor-driven actuator 32 associated with the base frame 2 and connected to the pinion element 31.

The rotation of the pinion element 31 causes the rotation of the rack body 30 and of the holding structure 29 around the central axis C.

The motor-driven actuator 32 is of the type of an electric motor.

The movement assembly also comprises a clamping system 33 adapted to block the holding structure 29 in the mixing position and in the metering position.

The function of the clamping system 33 is to keep the holding structure 29 and consequently the container body 3 stationary during the mixing and metering operations.

The clamping system 33 comprises a pin 34 movable by means of a pneumatic cylinder 35 between a free configuration wherein it allows the holding structure 29 to rotate and a clamping configuration wherein it is engaged with a respective seat 36 defined on the holding structure 29 and prevents the same from moving.

Conveniently, the holding structure 29 comprises at least one retaining portion 37 extending transversely to the central axis C and adapted to retain the container body 3.

In accordance with the embodiment shown in the figures, the retaining portion 37 comprises a pair of arms 38 that run transversely to the central axis C and between which the container body 3 can be positioned.

The movement assembly 28 comprises clamping members 39 positioned between the container body 3 and the retaining portion 37 and adapted to keep the container body 3 in the retaining portion 37. The clamping members 39 comprise a series of abutment elements 40 protruding from the container body 3 and adapted to be inserted into appropriate housings 41 defined on the respective arms 38. The clamping members 39 also comprise fastening elements 42, which are associated with the arms 38 and movable to keep the respective abutment element 40 in the housing 41.

Advantageously, the machine 1 comprises at least two of the container bodies 3 and the holding structure 29 comprises at least two of the retaining portions 37 arranged opposite each other with respect to the central axis C.

Specifically, the retaining portions 37 are arranged opposite each other with respect to a vertical plane passing through the central axis C.

The machine 1 then allows the transfer of the dairy product from a first container body 3 to the metering device 5 and, at the same time, the preparation of a new dairy product in a second container body 3. After the transfer is completed, the stirring device 18 and the pusher device 8 are placed in the receding position and in the home position respectively, and the movement assembly 28 transfers the first container body 3 and the second container body 3 to the mixing position and to the metering position, respectively.

It has in practice been ascertained that the described invention achieves the intended objects, and in particular, the fact is emphasized that the machine according to the invention for metering dense dairy products makes it possible to avoid the formation of air pockets upstream of the metering device.

In addition, the present machine allows constant and uninterrupted transfer of the dairy product to the metering device.

Finally, this machine allows for precise metering of the dairy product.

1) Machine (1) for metering dense dairy products, comprising:
at least one base frame (2);
at least one container body (3) defining a cavity (4) adapted to contain a dense dairy product;
at least one metering device (5) associated with said base frame (2) and adapted to dispense portions of said dairy product;
at least one transfer assembly (6) associated with said base frame (2), adapted to transfer said dairy product from said container body (3) to said metering device (5) and provided with at least one connecting duct (7) communicating with said cavity (4) and connected to said metering device (5);
wherein the fact that said transfer assembly (6) comprises at least one pusher device (8) movable within said container body (3) and adapted to exert a pressing force on said dairy product, said pressing force causing said dairy product to flow out of said container body (3) through said connecting duct (7).

2) Machine (1) according to claim 1, wherein the fact that it comprises at least one electronic unit (9) operationally connected to said metering device (5) and to said pusher device (8) and configured to operate the latter synchronously to dispense said portions of dairy product.

3) Machine (1) according to claim 1, wherein the fact that said pusher device (8) comprises at least one plunger body (10) movable along a substantially vertical operational direction (D) between a home position, wherein it is moved away from said container body (3), and at least one operating position, wherein it is arranged within said container body (3).

4) Machine (1) according to claim 1, wherein the fact that said connecting duct (7) is associated with said plunger body (10).

5) Machine (1) according to claim 1, wherein the fact that said pusher device (8) comprises actuating means (12) connected to said plunger body (10) and adapted to move the latter along said operational direction (D).

6) Machine (1) according to claim 1, wherein the fact that it comprises a mixing assembly (16) which is adapted to mix said dairy product within said container body (3), said container body (3) being movable between a mixing position, wherein it is arranged where said mixing assembly (16) is located, and a metering position, wherein it is arranged where said transfer assembly (6) is located.

7) Machine (1) according to claim 1, wherein the fact that said mixing assembly (16) comprises at least one stirring device (18) provided with at least one mixing element (19) insertable into said container body (3), said stirring device (18) being movable along a substantially vertical axis of work (W) between a receding position, wherein said mixing element (19) is pulled out of said container body (3), and a working position, wherein said mixing element (19) is arranged within said container body (3).

8) Machine (1) according to claim 1, wherein the fact that said mixing element (19) is movable in rotation around said axis of work (W).

9) Machine (1) according to claim 1, wherein the fact that said mixing element (19) develops along a relevant axis of development(S) substantially parallel to said axis of work (W), said mixing element (19) being rotatable around said axis of development (S).

10) Machine (1) according to claim 1, wherein the fact that said mixing assembly (16) comprises displacement means (25) adapted to move said stirring device (18) between said receding position and said working position and comprising:
at least one guide unit (26) associated with said base frame (2), extending parallel to said axis of work (W) and supporting said stirring device (18) by sliding; and
at least one actuator device (27) positioned between said base frame (2) and said stirring device (18).

11) Machine (1) according to claim 1, wherein the fact that said mixing assembly (16) and said transfer assembly (6) are arranged opposite each other with respect to a substantially vertical central axis (C) and by the fact that it comprises at least one movement assembly (28) associated with said base frame (2) and configured to move said container body (3) in rotation around said central axis (C) between said mixing position and said metering position.

12) Machine (1) according to claim 1, wherein the fact that said movement assembly (28) comprises a holding structure (29) adapted to hold said container body (3) and associated rotatable with said base frame (2) around said central axis (C) and an actuator system (20) adapted to set said holding structure (29) in rotation.

13) Machine (1) according to claim 1, wherein the fact that said actuator system (20) comprises:
at least one rack body (30) of circular conformation, locked together with said holding structure (29);
at least one pinion element (31) meshing said rack body (30); and
at least one motor-driven actuator (32) associated with said base frame (2) and connected to said pinion element (31);
where the rotation of said pinion element (31) causes the rotation of said rack body (30) and of said holding structure (29) around said central axis (C).

14) Machine (1) according to claim 1, wherein the fact that said holding structure (29) comprises at least one retaining portion (37) extending transversely to said central axis (C) and adapted to retain said container body (3) and by the fact that said movement assembly (28) comprises clamping members (39) positioned between said container body (3) and said retaining portion (37) and adapted to keep said container body (3) in said retaining portion (37).

15) Machine (1) according to claim 1, wherein the fact that it comprises at least two of said container bodies (3) and by the fact that said holding structure (29) comprises at least two of said retaining portions (37) arranged opposite each other with respect to said central axis (C).
